(19) United States
(12) Patent Application Publication
(10) Pub. No.: US 2007/0153115 A1
(43) Pub. Date: Jul. 5, 2007

(54) IMAGE PICKUP DEVICE

(75) Inventors: Takahiro UEDA, Tochigi (JP); Hideyuki Matsushita, Tochigi (JP); Keiji Komiya, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Sano-shi (JP)

(21) Appl. No.: 11/618,112

(22) Filed: Dec. 29, 2006

(30) Foreign Application Priority Data
Jan. 5, 2006 (JP) 2006-000516

(51) Int. Cl. G02B 13/16

(52) U.S. Cl. 348/335

(57) ABSTRACT

An image pickup comprising objective lens for forming an optical image of an object, a prism for turning a light path of light rays from said object, and a photoelectric solid-state image sensor for converting the optical image to electric signals. The prism has a plane of incidence for admitting the light rays from an object, a plane of reflection for turning a light path toward the solid-state image sensor, a plane of egression through which the light rays leave prism on the way to the solid-state image sensor, and an infrared cut coating in the form of an optical multi-layer coating deposited either on the plane of incidence or on the plane of egression for cutting off infrared components of incident light.

### BACKGROUND OF THE INVENTION

1. Field of the Art

This invention relates to an image pickup particularly suitable for use on a digital camera.

2. Prior Art

Generally, image pickups currently in use on digital cameras or video cameras are mainly composed of an optical lens system and a solid-state image sensor like CCD (Charge Coupled Device), taking light rays from an object into a photographic objective as incident light thereby to form an optical image of the object, picking up the image of the object by a solid-state image sensor which is located at the focus of the photographic objective lens. In addition to an objective lens, the lens system may further include a zooming lens and a focusing lens, and incident light is passed through these lenses to focus an image of an object on a predetermined part of the solid-state image sensor. Besides an optical lens system and a solid-state image sensor, an infrared cut filter is incorporated into an image pickup thereby to cut off infrared rays. A main reason for inclusion of an infrared cut filter is protection against heat radiation by infrared rays. Another reason is the sensitivity of the solid-state image sensor to infrared rays which are invisible to human eyes, necessitating to include an infrared cut filter to avoid problems such as conspicuous changes of colors of picked-up images from actual colors of an object and defocusing.

Lately, with a trend toward compact digital cameras, image pickups are required to be compact in shape and construction. In this regard, in Japanese Laid-Open Patent Application H11-205664, attempts are made to provide an image pickup of a compact form. More particularly, in Japanese Laid-Open Patent Application H11-205664, attempts are made to downsize the depth of an image pickup by incorporating a reflecting mirror prism in the form of an isosceles right triangle pole in a position posterior to an objective lens, thereby turning a light path in a sideward direction toward a solid-state image sensor which is located sideward of the prism.

In the case of Japanese Laid-Open Patent Application H11-205664, a reflecting mirror prism of an isosceles right triangle pole is resorted to for the purpose of compactifying an image pickup as a whole. However, recently there are strong and increasing demands for compact digital cameras, necessitating to develop image pickups which are further compactified in construction. An infrared cut filter which is incorporated into an image pickup to cut off infrared components of incident light has a problem that it can give adverse effects on picture images if located in the proximity of a solid-state image sensor device. That is to say, in a case where an infrared cut filter (IR cut filter) is located in close proximity to a solid-state image sensor device, even a minute contaminant or a foreign particle which has deposited on the IR cut filter or a flaw on the filter can give adverse effects to the quality of picture images to be captured because it is recognized by the solid-state image sensor. Therefore, if an IR cut filter is located in a position immediately anterior to a solid-state image sensor device as in Japanese Laid-Open Patent Application H11-205664 mentioned above, it is very likely that dust or foreign particle on the IR cut filter is recognized by the solid-state image sensor device, resulting in a degradation of picture quality.

### SUMMARY OF THE INVENTION

With the foregoing situations in view, it is an object of the present invention to provide an image pickup which is compactified in construction and yet capable of suppressing adverse effects of an infrared cut filter on picture images to be captured

According to the present invention, in order to achieve the above-stated objective, there is provided an image pickup comprising objective lens for forming an optical image of an object, a prism for turning a light path of light rays from the object, and a photoelectric solid-state image sensor adapted to convert the optical image to electric signals, characterized in that the prism comprises: a plane of incidence for admitting light rays from the object, a plane of reflection for turning a light path of the light rays through a predetermined angle toward the solid-state image sensor, and a plane of egression through which the light rays leave the prism on the way to the solid-state image sensor; and an infrared cut coating in the form of an optical multi-layer coating deposited either on the plane of incidence or on the plane of egression of the prism to cut off infrared components of incident light.

The above and other objects, features and advantages of the invention will become apparent from the following particular description, taken in conjunction with the accompanying drawing which show by way of example a preferred embodiment of the invention. Needless to say, the present invention should not be construed as being limited to particular forms shown in the drawing.

### BRIEF DESCRIPTION OF THE DRAWING

In the accompanying drawing:

FIG. 1 is a schematic view of an image pickup device showing one embodiment of the present invention; and

FIG. 2 is a schematic view of an image pickup device showing another embodiment of the present invention.

### DESCRIPTION OF PREFERRED EMBODIMENTS

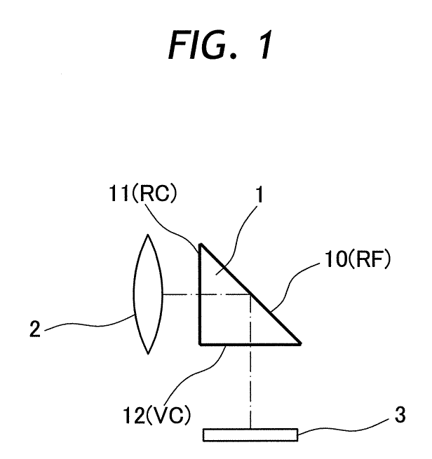

Hereafter, the present invention is described more particularly by way of its preferred emdbodiment shown in the accompanying drawing. As shown in FIG. 1, an image pickup according to the present invention is composed of a prism 1, a objective lens 2 and a solid-state image sensor 3. This image pickup has been developed with an intention for use on a compact digital camera, but of course it can be applied as an image pickup of a video camera or other optical appliances.

As shown in FIG. 1, an optical image of an object is produced on the solid-state image sensor 3 by an image-forming action of the objective lens 2. The prism 1 is located in a position posterior to the lens 2 for turning a light path. In the embodiment shown in FIG. 1, for example, the prism 1 is in the shape of an isosceles right triangle pole. A substrate plate like a glass substrate plate is applied as material for the prism 1. Of the three lateral planes of the prism 1, light enters through one lateral plane (plane of incidence 11), and reflected by one of two remaining lateral planes (plane of reflection 10) toward the solid-state image sensor 3, leaving the prism 1 through the third lateral plane (plane of egression 12). The prism 1 is not necessarily required to be in the shape of a triangle pole but should have at least a plane of reflection 10, a plane of incidence 11 and a plane of egression 12.

In the case of the particular embodiment shown in FIG. 1, the prism 1 is of a triangle pole which is in the shape of an isosceles right triangle in cross-section. The plane of incidence 11 and the plane of egression 12 are located on two sides of a right triangle which are disposed at right angles with each other, and the plane of reflection 10 is located on the remaining side of the right triangle. In this instance, the plane of incidence 11 is disposed perpendicularly to the traveling direction of light from an object. Thus, the plane of reflection 10 is disposed at an angle of 45 degrees relative to the plane incidence 11, and a light path of light rays from an object is turned through 90 degrees on reflection by the plane of reflection 10. Of course, in case the plane of reflection 10 is disposed at an angle other than 45 degrees relative to the direction of a light path of incident light, the light path can be turned through a different angle.

The lens 2 is an objective lens which forms an image of an object on the solid-state image sensor 3. The light path of light rays which have been passed through the lens 2 is turned by the prism 1 toward the solid-state image sensor 3 to form an image on a predetermined position of the latter. In FIG. 1, a single objective lens is exemplified as the lens 2. However, the lens 2 may additionally include a focusing lens and a zoom lens for focusing and zooming functions. Further, in addition to a lens which is positioned on the input side of the prism 1, the lens 2 may include a lens which is positioned on the output side of the prism 1 as explained hereinlater. The solid-state image sensor 3 is a photoelectric device like CCD. An optical image of an object which is produced on the solid-state image sensor 3 by the lens 2 is converted into electric signals by photoelectric conversion.

Photoelectric elements of the solid-state image sensor generate luminance signals according to the intensity of incident light, and colorization can be realized by forming color filters in photoelectric elements. In the case of a digital camera, from electric signals generated by the solid-state image sensor 3, eventually a picture image of an object is produced after predetermined image processing by a DSP (Digital Signal Processor) which is not shown.

In this instance, in order to turn a light path from an object, the prism 1 needs to have a reflective coating RF on the plane of reflection 10. Regarding the methods for forming a reflective coating RF on the plane of reflection 10 of the prism 1, it is conceivable to form a reflective coating on the plane of reflection 10 by alternately depositing a high refractivity layer and a low refractivity layer by a vacuum deposition process, ion plating process, ion assist process or sputtering process. By the reflective coating RF which is formed on the plane of reflection 10 of the prism 1, a light path from an object is turned through 90 degrees.

In addition, an infrared cut coating RC is deposited on one of remaining plane lateral surfaces other than the plane of reflection 10, namely, on the plane of incidence 11, and an ultraviolet cut coating VC is deposited on the other one of the remaining plane lateral surfaces, namely, on the plane of regression. The infrared cut coating RC is a multi-layer optical coating functions to cut off infrared components of incident light in the same way as an infrared cut filter. The infrared cut coating RC can be formed on the plane of incidence 11 of the prism 1, for example, by alternately depositing a high refractivity layer of TiO₂ and a low refractivity layer of SiO₂ until the number of laminated layers reaches 50.

On the other hand, the ultraviolet cut coating VC functions to cut off ultraviolet components of incident light. The solid-state image sensor 3 is sensitive to ultraviolet rays beside infrared rays, so that, without the ultraviolet cut coating VC, blurring of contours or outlines in violet can occur due to chromatic aberrations. The ultraviolet cut coating VC can be deposited on the plane of egression 12 of the prism 1, for example, by alternately depositing a high refractivity layer of TiO₂ or Nb₂O₅ and a low refractivity layer of SiO₂ for 40 to 50 layers in total.

Normally, for cutting off infrared and ultraviolet rays, an infrared cut filter and an ultraviolet cut filter are assembled into the image pickup as separate and independent components. However, the use of such independent components for the infrared and ultraviolet cut filters invariably results in an image pickup which lacks compactness. In contrast, in the case of the image pickup according to the invention, infrared and ultraviolet rays are cut off by optical multi-layer coatings which are deposited on two plane lateral surfaces of a prism which is incorporated in the image pickup to turn a light path toward a solid-state image sensor, obviating to use independent optical components exclusively for cutting off infrared and ultraviolet rays. Omission of even one optical component has a great significance from the standpoint of compactifisation of the image pickup as a whole. That is to say, omission of both of infrared cut filter and ultraviolet cut filter, which have thus far been resorted to and incorporated as independent components, can greatly contribute to compactification of the image pickup device.

Cutoff of infrared rays is essential to an image pickup device. Namely, from the standpoint of protection against heat radiations of infrared rays and precluding adverse effects of infrared rays on actually captured picture images (color changes and defocusing), the infrared cut coating RC has to be formed on the prism 1. On the other hand, the ultraviolet cut coating VC which contributes to the improvement of picture quality. However, omission of the ultraviolet cut coating VC would not bring about conspicuous degradations in quality of picture images to be obtained. Therefore, it is preferable to provide the ultraviolet cut coating VC on the prism 1 but it is not an essential element. That is to say, at least the infrared cut coating RC should be formed on the prism 1.

In the embodiment shown in FIG. 1, the lens 2 is located anterior to the prism 1 in the path of light rays from an object. However, in a case where the lens 2 is composed of a plural number of lens elements for focusing and zooming functions, part of the lens elements can be located between the prism 1 and the solid-state image sensor. In such a case, by location of a lens element between the prism 1 and the solid-state image sensor 3, the length of the light path from the prism 1 to the solid-state image sensor 3 becomes longer, increasing the chances of suppressing adverse effects of dust or foreign particles on picture images to be obtained. Namely, deposition of dust or foreign particles or existence of a flaw on a functional surface for cutoff of infrared rays (i.e., a filter surface in the case of a conventional IR cut filter and the plane of egression 12 in the case of the present invention) is recognized by the solid-state image sensor 3 when the latter is located closely to the functional surface, giving adverse affect to picture images to be captured through the image sensor.

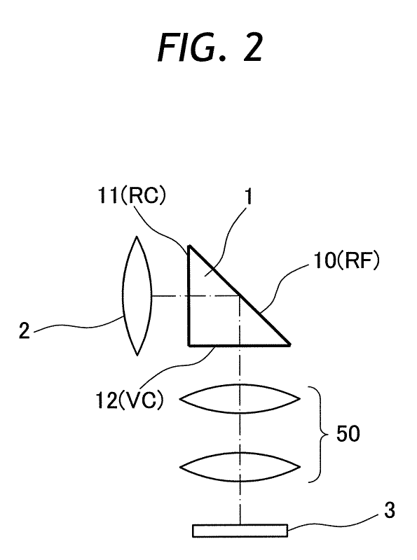

As shown in FIG. 2, when one or a plural number of lens elements 50 is located between the prism 1 and the solid-state image sensor 3, the length of the light path from the prism 1 to the solid-state image sensor 3 can be elongated to suppress adverse effects of dust or foreign particles. Thus, from the standpoint of suppressing adverse effects, it is preferred to elongate the light path between the prism 1 and the solid-state image sensor 3. In case no lens element is located between the prism 1 and the solid-state image sensor 3, the light path can be elongated by forming the infrared cut coating RC on the plane of incidence 11 of the prism 1. Thus, the above-mentioned adverse effects of foreign particles or flaw can be suppressed even in a case where no lens element is located between the prism 1 and the solid-state image sensor 3. Of course, considering the effects on picture images, it is desirable to form the infrared cut coating RC on the plane of incidence 11 of the prism 1. However, in applications where foreign particle or flaw is extremely minute and has little influence on picture images, the infrared cut coating RC may be formed on the plane of egression 12 of the prism 1.

In order to prevent light reflections, normally it is required to provide anti-reflection coating on the plane of incidence 11 as well as on the plane of egression 12 of the prism 1. However, the infrared cut coating RC as well as the ultraviolet cut coating VC can also play a role of an anti-reflection coating. In a case where the prism 1 is provided with only the infrared cut coating RC and not with the ultraviolet cut coating VC, an anti-reflection coating is formed on either the plane of incident 11 or the plane of egression 12 on which no infrared cut coating RC is formed.

As described above, according to the present invention, an image pickup device as a whole is compactified by providing an infrared cut coating RC on one of two lateral planes other than a plane of reflection (i.e., either on a plane of incidence 11 or on a plane of egression 12) of a triangle pole prism 1 which is generally used for the sake of compactness of the pickup device, obviating to incorporate an independent infrared cut filter exclusively for the purpose of cutting off infrared rays. Further, in case it is desired to cut off ultraviolet rays as well, an ultraviolet cut coating VC can be formed on a lateral plane on which neither reflective coating RF nor infrared cut coating RC is formed, also obviating to incorporate an independent ultraviolet cut filter exclusively for the purpose of cutting off ultraviolet rays. Thus, the image pickup device according to the present invention is compactified in construction as a whole and yet capable of picking up picture images of higher quality. Besides, adverse effects of foreign particles or a flaw can be suppressed in a case where a lens element is located between the prism 1 and solid-state image sensor 3, or in a case where the infrared cut coating RC is formed on the plane of incidence 11 of the prism 1. Thus, the present invention has succeeded in compactifying an image pickup device as a whole while at the same time eliminating adverse effects of foreign particles or flaw on picture images to be captured.

What is claimed is:

1. An image pickup comprising an objective lens for forming an optical image of an object, a prism for turning a light path of light rays from said object, and a photoelectric solid-state image sensor adapted to convert said optical image to electric signals, characterized in that said prism comprises:
a plane of incidence for admitting light rays from said object, a plane of reflection for turning a light path of said light rays through a predetermined angle toward said solid-state image sensor, and a plane of egression through which said light rays leave the prism on the way to said solid-state image sensor; and
an infrared cut coating in the form of an optical multi-layer coating deposited either on said plane of incidence or on said plane of egression of the prism to cut off infrared components of incident light.

2. An image pickup as defined in claim 1, further comprising an ultraviolet cut coating deposited either on said plane of incidence or on said plane of egression whichever has no infrared cut coating, cutting off ultraviolet components of incident light by said ultraviolet cut coating.

3. An image pickup as defined in claim 1, wherein said prism is in the shape of a triangle pole having three lateral planes to function as said plane of incidence, plane of reflection and plane of egression, respectively.

4. An image pickup as defined in claim 1, wherein one or a plural number of lens elements are positioned between said prism and said solid-state image sensor.

5. An image pickup as defined in claim 1, wherein said infrared cut coating is constituted by an optical multi-layer coating formed by alternately laminating a high refractivity layer of TiO₂ and a low refractivity layer of SiO₂ up to approximately 50 layers in total.

6. An image pickup as defined in claim 2, wherein said ultraviolet cut coating is constituted by an optical multi-layer coating formed by alternately laminating a high refractivity layer substance selected from TiO₂ and Nb₂O₅, and a low refractivity layer of SiO₂ up to approximately 40 to 50 layers in total.
